(19) United States
(12) Patent Application Publication
(10) Pub. No.: US 2025/0240689 A1
(43) Pub. Date: Jul. 24, 2025

(54) ANALYSIS AND OPTIMIZATION BASED ON INTER RADIO ACCESS TECHNOLOGY TRANSITION TRACKING

(71) Applicant: T-Mobile Innovations LLC, Overland Park, KS (US)

(72) Inventors: Roy Vincent MONSALUD, Downers Grove, IL (US); Manjith BAHULEYAN, Bothell, WA (US); Marc Maurice MESHREKY, Bothell, WA (US)

(21) Appl. No.: 18/415,900

(22) Filed: Jan. 18, 2024

(51) Int. Cl. H04W 36/14

(52) U.S. Cl. CPC H04W 36/14

(57) ABSTRACT

Systems, methods and devices are provided for improving network performance by performing optimizations to minimize inter-radio access technology (IRAT) transitions. A method includes tracking the IRAT transitions in conjunction with correlating variables, identifying excessive IRAT transitions meeting a threshold and performing an optimization based on the identification and the correlating variables.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)) and 6G RATs. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs.

With introduction of 5G Standalone (SA) networks, wireless devices may now be able to connect to two independent RATs, depending on their coverage and usage. Wireless devices may be subject to inter-RAT (IRAT) handovers, for example from 5GSA to 4G LTE when they move outside of SA coverage. Further, because 4G or LTE is a more mature RAT than 5G and thus provides additional services, wireless devices may be subject to IRAT handovers when they are connected to 5GSA and need services like voice that are not yet universally available in 5GSA. Each IRAT handover comes with some interruption in service due to required call flow procedures across two different RATs.

Further, scenarios exist in which wireless devices engage in ping-pongs across both 4GLTE and 5GNR by performing continuous IRAT handovers. These scenarios may include, for example, being on a 5GSA coverage edge, using services such as voice that are not universally available on the 5GSA network, network misconfigurations in the access nodes, and specific original equipment manufacturer (OEM) implementations for the wireless devices when they are connected to Wi-fi. Such scenarios could result in increased capacity requirements for the core network due to the intensive resource usage required for IRAT transitions. The excessive IRAT transitions also results in poor user experience.

### OVERVIEW

Exemplary embodiments track IRAT transitions and perform optimization based on the tracked transitions in order to improve wireless device and network performance. Accordingly, improvements are provided herein that overcome the above-described deficiencies in order to minimize unnecessary IRAT transitions.

Exemplary embodiments described herein include systems, methods, processing nodes, and non-transitory computer-readable mediums for tracking IRAT transitions and recommending optimizations based on the tracked IRAT transitions. A method includes tracking inter-radio access technology (IRAT) transitions within a network and comparing a number of IRAT transitions per user to a threshold. The method further includes identifying excessive IRAT transitions based on the comparison and generating a recommendation for optimization based on the identification. In embodiments provided herein, the method may further include tracking the IRAT transitions in conjunction with at least one correlating variable and making the recommendations for optimization based on the correlating variable.

In an additional embodiment, a system is provided including a memory storing data and instructions, the data including at least a threshold number of inter-radio access technology (IRAT) transitions per user. The system further includes a processor accessing the stored data and executing the stored instructions to perform multiple operations. The operations include tracking IRAT transitions within a network and comparing a number of IRAT transitions per user to the stored threshold. The operations further include identifying excessive IRAT transitions based on the comparison and generating a recommendation for resource optimization based on the identification.

In yet a further embodiment, a non-transitory computer readable medium storing instructions is provided. When executed by a processor, the instructions cause multiple operations to be performed. The operations include tracking IRAT transitions within a network in conjunction with correlating variables and comparing a number of IRAT transitions per user to a threshold. The operations further include identifying excessive IRAT transitions based on the comparison and generating a recommendation for resource optimization based on the identification and the correlating variables.

### BRIEF DESCRIPTION OF THE DRAWINGS

FIG. 1 depicts an exemplary operating environment for employing an inter radio access technology (IRAT) transition analyzer in accordance with the disclosed embodiments.

FIG. 2 illustrates an additional exemplary operating environment for an IRAT transition analyzer in accordance with disclosed embodiments.

FIG. 3 illustrates an exemplary configuration for an IRAT analyzer in accordance with disclosed embodiments.

FIG. 4 depicts an exemplary method in accordance with disclosed embodiments.

FIG. 5 depicts a further exemplary method in accordance with the disclosed embodiments.

FIG. 6 depicts an interface produced during performance of the above-described methods.

FIG. 7 depicts an additional interface produced in conjunction with embodiments disclosed herein.

FIG. 8 depicts a further interface produced in conjunction with embodiments disclosed herein.

FIG. 9 depicts a further interface produced in conjunction with embodiments disclosed herein.

FIG. 10 depicts a further interface produced in conjunction with embodiments disclosed herein.

### DETAILED DESCRIPTION

Exemplary embodiments described herein include systems and methods for tracking IRAT transitions, analyzing the tracked IRAT transitions, and performing optimization to minimize the IRAT transitions in order to improve wireless device and network performance. The optimizations can include, for example, optimizations to the core network, to the RAN, or to particular wireless devices. Regardless of the particular optimizations, methods described herein improve end user experience by minimizing ping pong transitions across multiple RATs and by extending battery life of the wireless device. Further, systems and methods described herein improve network performance, for example by contributing to efficient capacity management of the unified data management (UDM) of the core network.

While IRAT transitions may be due to the movement of devices, they also occur due to poor signal quality, unavailability of services requested by devices on a particular RAT, manufacturer settings for particular device models, and network misconfigurations. Embodiments provided herein track IRAT transitions and analyze the tracked IRAT transitions across multiple variables, for example, across markets, cell sites, device models, vendor, subscriber, tracking area code (TAC) (which represents a subset of the market between site level and market level), and radio frequency (RF) bands to determine where excessive IRAT transitions are concentrated in order to make optimization recommendations based on this knowledge.

Wireless devices may be slow to evolve to be able to leverage newer RATs. For example, while most existing wireless devices are 4G capable, a smaller percentage of wireless devices are 5G capable. Of those wireless devices that are 5G capable, most are backwards compatible so that they may be subject to transitions between 4G and 5G RATs. With the evolution of 5G standalone (SA), in which the core network has a 5G service-based architecture (SBA), wireless devices transitioning between 4G and 5G RATs are transitioning between different core networks, which can be particularly time and resource intensive.

Network operators strive to have devices utilize the newer RAT, e.g., 5G NRSA, which has increased benefits of larger bandwidths, increased speed, and network slicing. However, when devices are not capable of using the newer 5GNRSA RAT, they fall back to 4GLTE. This can be due to the innate incapability of the device, or the lack of a particular service, e.g., voice service or VoNR on the 5G NRSA RAT. Further, devices that are 5G capable often transition to 4G based on signal conditions differentials. All of these IRAT transitions require multiple communications between the wireless device, multiple base stations, and multiple core network components such as the 5G AMF and the 4G MME. The additional communication increases capacity requirements for core functions such as the UDM, making it difficult to maintain. It also results in poor user experience due to such IRAT ping-pongs. The communication is time and resource intensive and thus the IRAT transitions diminish the performance of both the wireless device and the network.

Accordingly, embodiments herein implement tracking by utilizing an “IRAT transition per user” measurement to quantify the excessive and unwanted signaling towards the core network that occurs during IRAT transitions. In particular, the signaling reaches a unified data management (UDM) of subscribers of the 5G CORE network such that the 5G core experiences a high number of transactions per second (TPS). Embodiments provided herein may reduce the unwanted signaling towards the core network or expand core network coverage in order to minimize IRAT transitions per user. Managing IRAT transitions impacts a network's capacity, risk and cost. High IRAT transitions can be managed, for example, with a higher capacity at the core network, which comes at higher cost. Minimizing IRAT transitions enables better service without unnecessary expenditures.

The IRAT transitions per user measurement can be generated by utilizing the access and mobility management function (AMF) per call measurement data (PCMD) logs. Further embodiments provided herein create a dashboard tool using the IRAT transitions per user measurement. The provided dashboard tool is used for analysis and provides the ability to drill-down by multiple variables, for example, subscriber level as indicated by the international mobile subscriber identity (IMSI), by cell site, by TAC, by market, by device, by RF band, and by vendor. Further, the analysis may compare a number of IRAT transitions per user to a particular threshold to identify cell sites, markets, devices, frequency bands etc. that have a particular problem with excessive IRAT transitions per user. The analysis ability provided through the dashboard tool facilities the functionality of generating recommendations for optimizations to both the RAN and the core network. The optimizations result in a reduction of transactions per second (TPS) and an overall improvement in network performance.

Embodiments disclosed herein identify a threshold number of inter-RAT transitions for wireless devices across multiple monitored variables and thus are able to identify hotspots where optimizations are necessary as well as the types of optimizations required. For example, based on characteristics of these hotspots, optimizations may be performed on the core network, the RAN, or the wireless devices in order to reduce the number of IRAT transitions.

In addition to the systems and methods described herein, the operations for tracking IRAT transitions, analyzing the IRAT transitions, and performing optimizations may be implemented as computer-readable instructions or methods, and processing nodes on the network for executing the instructions or methods. The processing node may include a processor included in the access node or a processor included in any controller node in the wireless network that is coupled to the access node.

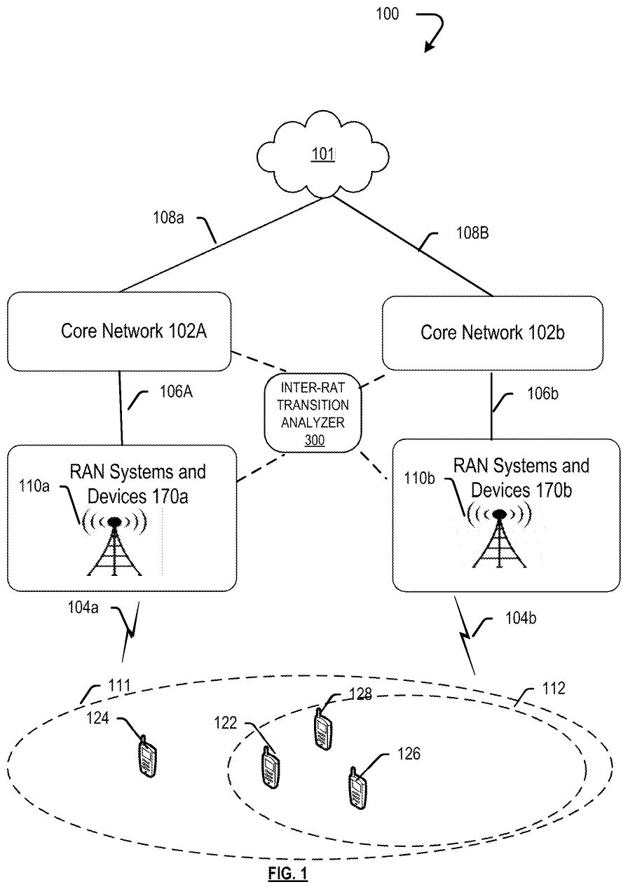

FIG. 1 depicts an exemplary environment 100 for wireless communication, in accordance with the disclosed embodiments. The environment 100 may include a communication network 101, multiple core networks 102a and 102b, and radio access networks (RANs) 170a and 170b, each including at least one access node 110a and 110b. The core networks 102a and 102b are connected to the communication network 101 over communication links 108a and 108b. The RANs 170a and 170b may include other devices and additional access nodes. The environment 100 also includes multiple wireless devices 122, 124, 126, and 128, which may be end-user wireless devices and may operate within one or more coverage areas 111 and 112 and communicate with the RANs 170a and 170b over communication links 104a and 104b, which may for example be 5G NR and 4G LTE communication links.

The environment 100 may further include an inter rat (IRAT) transition analyzer 300, which is illustrated as operating between the core networks 102a and 102b and the RANs 170a and 170b. However, it should be noted that the IRAT transition analyzer 300 may be distributed. For example, the IRAT transition analyzer 300 may utilize components located at both the core networks 102a and 102b, at multiple access nodes 110a and 110b. Alternatively, the IRAT transition analyzer 300 may be an entirely discrete component operating between the core networks 102a, 102b and the RANs 170a and 170b.

The IRAT transition analyzer 300 obtains information pertaining to the IRAT transitions per user in relation to variables such as IMSI, cell site, TAC, market, wireless device model or type, RF band, and vendor. The information may be obtained for example from PCMD logs of the AMF in the core network 102a, 102b. Further, the wireless devices 122, 124, 126, and 128 further may send a type including a make and model to the RAN, which may be collected by the IRAT transition analyzer 300.

The IRAT transition analyzer 300 incorporates a structure for analyzing this information with a goal of optimization. The analysis may relate the number of IRAT transitions per user to any of the above-identified variables. For example, the analysis may compare a number of IRAT transitions per user for a particular device, such as the iPhone® 13 to a predetermined network-specific threshold. If the number of IRAT transitions per user for the iPhone® 13 meets or exceeds the threshold, the analyzer may recommend an optimization. The optimization may apply to the core network 102a, 102b, or the RAN 170a, 170b. For example, in this instance, settings in the core network or the RAN may override setting of the wireless device to minimize the IRAT transitions and improve performance. As another example, the IRAT transition analyzer 300 may compare the number of IRAT transitions per user within a cell site to a predetermined threshold. If the number of IRAT transitions per user exceeds the predetermined threshold, the IRAT transition analyzer 300 may make recommendations for RAN optimizations. For example, handover thresholds within the RAN could be altered to minimize IRAT transitions.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless devices 122, 124, 126, 128. Wireless network protocols can comprise MBMS, code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

The core networks 102a and 102b include core network functions and elements. One core network, e.g. 102a, may have an evolved packet core (EPC) structure and the other core network, e.g. 102b may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QOS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 122, 124, 126, 128 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although two core networks 102a and 102b are shown, a single core network 102 may be utilized that includes a distributed, cloud-native, converged core gateway instead of two distinct core networks. For example, the core networks 102a and 102b and 102b may include a cloud native converged core network including both 5GSA and 4G. Thus, the converged core gateway could connect a 4G LTE evolved packet core (EPC) to a 5G core network.

Communication links 106a, 106b and 108a, 108b can use various communication media, such as air, space, metal, optical fiber, or some other signal propagation path, including combinations thereof. Communication links 106a, 106b and 108a, 108b can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication links 106a, 106b and 108a, 108b can be direct links or might include various equipment, intermediate components, systems, and networks, such as a cell site router, etc. Communication links 106a, 106b, 108a, and 108b may comprise many different signals sharing the same link. Communication links 106a, 106b, 108a, and 108b may be associated with many different reference points.

The RANs 170a and 10b may include various access network systems and devices such as access nodes 110a and 110b. The RANs 170a and 170b are disposed between the core networks 102a and 102b and the end-user wireless devices 122, 124, 126, 128. Components of the RANs 170a and 170b may communicate directly with the core networks 102a and 102b and others may communicate directly with the end user wireless devices 122, 124, 126, 128. The RANs 170a and 170b may provide services from the core networks 102a and 102b to the end-user wireless devices 122, 124, 126, and 128.

The RANs 170 includes at least an access node (or base station) 110, 120 such as an eNodeB 110a and a gNodeB 110b communicating with the plurality of end-user wireless devices 122, 124, 126, 128. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB. Further, although two RANs 170a and 170b are shown, additional RANs or a single combined RAN may be utilized.

Access nodes 110a, 110b can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access nodes 110a, 110b may comprise a short range, low power, small-cell access node such as a microcell access node, a picocell access node, a femtocell access node, or a home eNodeB device. Access nodes 110a, 110b can be configured to deploy one or more different carriers, utilizing one or more RATs. For example, a gNodeB may support NR and an eNodeB may provide LTE coverage. Any other combination of access nodes and carriers deployed therefrom may be evident to those having ordinary skill in the art in light of this disclosure.

The access nodes 110a, 110b can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Furthermore, in embodiments set forth herein, the access nodes 110a, 110b store default handover thresholds and existing handover rules. Further, in embodiments set forth herein, the access nodes 110a, 110b are able to interact with the IRAT transition analyzer 300 to minimize excessive IRAT transitions through various optimizations.

The wireless devices 122, 124, 126, and 128 may include any wireless device included in a wireless network. For example, the term “wireless device” may include a relay node, which may communicate with an access node. The term “wireless device” may also include an end-user wireless device, which may communicate with the access node in the access network 170a, 170b through the relay node. The term “wireless device” may further include an end-user wireless device that communicates with the access node directly without being relayed by a relay node.

Wireless devices 122, 124, 126, and 128 may be any device, system, combination of devices, or other such communication platform capable of communicating wirelessly with access network 110 using one or more frequency bands and wireless carriers deployed therefrom. Each of wireless devices 122, 124, 126, and 128, may be, for example, a mobile phone, a wireless phone, a wireless modem, a personal digital assistant (PDA), a voice over internet protocol (VOIP) phone, a voice over packet (VOP) phone, or a soft phone, an internet of things (IoT) device, as well as other types of devices or systems that can send and receive audio or data. The wireless devices 122, 124, 126 128 may be or include high power wireless devices or standard power wireless devices. Other types of communication platforms are possible.

Environment 100 may further include many components not specifically shown in FIG. 1 including processing nodes, controller nodes, routers, gateways, and physical and/or wireless data links for communicating signals among various network elements. Environment 100 may include one or more of a local area network, a wide area network, and an internetwork (including the Internet).

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the access networks 170a and 170b and the core networks 102a and 102b.

The operations for optimization to minimize IRAT transitions may be implemented as computer-readable instructions or methods, and processing nodes on the network for executing the instructions or methods. The processing node may include a processor included in the access node or a processor included in any controller node in the wireless network that is coupled to the access node.

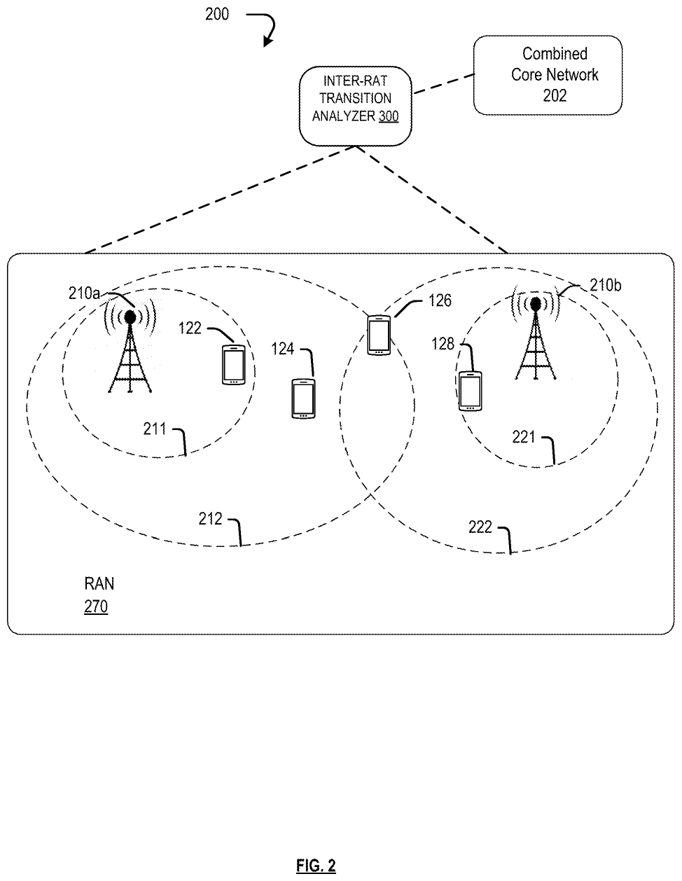

FIG. 2 depicts an exemplary operating environment 200 for an IRAT analyzer 300 accordance with the disclosed embodiments. The operating environment 200 may include a RAN 270, which may include components for two different RATs. For example, the access nodes may include a combined eNB and gNB at both 210a and 210b. Thus both access nodes 210a and 210b operate using both 4G LTE and 5G NR. Wireless devices 122, 124, 126, and 128 may communicate over the RAN 270. The wireless devices 122, 124, 126, 128 may be end-user wireless devices and may operate within one or more coverage areas 211, 212, 221, and 222 of the access nodes 210a and 210b.

While like reference numbers may refer to the elements described above with respect to FIG. 1, the environment 200 may include additional nodes similar to access nodes 210a and 210b. Further, these access nodes 210a and 220b may each operate within two different RATs and may thus each have two different coverage areas 211, 212, 221, and 222. For example, coverage area 211 may be a 5G coverage area of access node 210a and coverage area 212 may be a 4G LTE coverage area of the access node 210a. Further, a coverage area 221 may be a 5G coverage area of access node 210b and coverage area 222 may be a 4G LTE coverage area of access node 210b. As illustrated, the access nodes 210a and 210b may serve at least one wireless device 122, 124, 126, and 128 in the above-described coverage areas 211, 212, 221, and 222.

When both the access nodes 210a and 210b provide multi-RAT coverage through a co-located eNB and gNB, IRAT handovers may occur. For example, the wireless device 122 is shown as located within the coverage areas 211 and 212. The coverage area 211 may be, for example, a 5G NR coverage area, and the coverage area 212 may be, for example, a 4G LTE coverage area. Thus, the gNB may operate on a higher RF band than the eNB, but will have a lower coverage footprint and the eNB operates at a lower RF band, but has a higher coverage footprint. While wireless devices 122, 124, 126, and 128 may be subject to IRAT handovers due to mobility, they may also be subject to IRAT handovers in other situations. In some cases, the wireless device 122 may be forced into an evolved packet system (EPS) fallback when the 5G NR coverage of the access node 210a cannot be provided. For example, if the wireless device 122 requests a voice call and the gNB does not offer voice service, the wireless device 122 will be released from 5G coverage and will re-select 4G coverage. Further, because the wireless device 122 is at the edge of the 5G coverage area 211, the signal quality of the 4G coverage area 212 may be better than that in the 5G coverage area. Thus, the wireless device 122 may also be subject to an EPS fallback in this situation. While this description pertains to a 5G to 4G handover, it should be understood that handovers can also occur in the reverse direction, from 4G to 5G. For example, the wireless device 128 may be handed over from 4G coverage provided in coverage area 222 to 5G coverage provided by coverage area 221. The handover may be due to mobility or to signal conditions being better for the 5G coverage than for the 4G coverage.

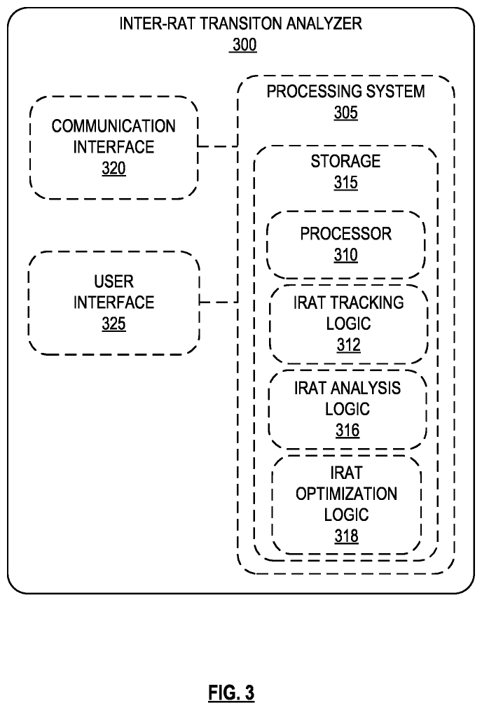

The IRAT analyzer 300 may be a separate component that communicates with the access nodes 210a and 210b and may also communicate with a converged core network 202. The IRAT analyzer 300 may be substantially as described herein with respect to FIG. 3 and may track and analyze IRAT transitions in order to provide a recommendation for optimization. Recommendations for optimization may include, for example, whether the wireless devices 122, 124, 126, 128 operate in accordance with stored policies, for example, a default handover threshold stored at the access node, or whether the stored policies should be overridden for the wireless device 122, 124, 126, 128 in order to minimize IRAT handovers. For example, the IRAT transition controller 300 may accept existing thresholds unless a wireless device has been subject to repeated IRAT handovers during a predetermined durations, where the number of IRAT handovers meets a predetermined network threshold. In this instance the IRAT transition analyzer 300 may identify and override a handover threshold. Alternatively, the IRAT analyzer 300 may identify a device model and determine that the device model should be assigned to a predetermined RAT for a specific time period based on continuous ping-ponging.

FIG. 3 depicts an exemplary IRAT analyzer 300, which may be configured to perform the methods and operations disclosed herein to perform optimization to minimize IRAT transitions. In the disclosed embodiments, the IRAT analyzer 300 may be integrated with the core network 102a, 102b, 202 or may be an entirely separate component capable of communicating with the access nodes 110a, 110b, 210a, 210b, core network 102a, 102b, 202 and/or the wireless devices 122, 124, 126, 128.

The IRAT analyzer 300 may be configured to track IRAT transitions across multiple variables, analyze the tracked transitions, and perform optimizations based on the analysis. The IRAT transition analyzer 300 may include a processing system 305. Processing system 305 may include a processor 310 and a storage device 315. Storage device 315 may include a disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software.

For example, software stored in storage device 315 may include one or more modules for performing various operations described herein. For example, instructions 312 may be provided to track IRAT transitions per user. The IRAT transition analyzer 300 may utilize instructions 312 to access the AMF and UDM of the core network to determine the metric of IRAT transitions per user for each user across multiple variables for a particular time period. The variables may include, for example, market, vendor, cell site, subscriber identity, frequency band, and TAC.

The IRAT transition analyzer 300 may further include IRAT transition analysis logic 316. The IRAT transition analysis logic 316 may be utilized to identify outliers based on the tracked data. For instance, the IRAT transition analysis logic 300 may be utilized to identify each user having a number of IRAT transitions in a particular time period that meets or exceeds a predetermined threshold. For example, the time period may be twenty four hours and the number of transitions per device may be one hundred. Thus, each user that exceeds the one hundred IRAT transitions per twenty four hour period may be flagged during the analysis. Further, these users exceeding the threshold will be analyzed with relation to the above-identified tracking variables. For example, a cell site will be flagged if it includes a second threshold number or percentage of users experiencing the above described threshold number of IRAT transitions. Likewise, a device model may be flagged if the percentage of device users experiencing the threshold number of IRAT transitions exceeds a threshold percentage of device users. Accordingly, two thresholds may be utilized by the IRAT transition analyzer. A first threshold applies to the number of IRAT transitions per user and a second threshold applies to the number of percentage of these users experiencing excessive transitions in relation to one of the above-identified variables.

Further, the IRAT transition analyzer 300 may include IRAT optimization logic 318. The IRAT optimization logic 318 may select an optimization method based on the above-described analysis. For example, if all types of devices in a particular location are experiencing excessive IRAT transitions, the IRAT optimization logic may recommend or trigger a RAN optimization for an access node serving the wireless devices. For example, a transmission angle or transmit power of the base station may be adjusted. Alternatively, when a particular geographical market including multiple cell sites experiences excessive IRAT transitions per user, the IRAT optimization logic 318 may recommend or trigger a core network optimization to extend a standalone coverage area. The threshold number of users may be determined, for example, using a percentage or a predetermined number. As a further alternative, when the IRAT transition analysis logic 316 determines that a particular type of device is experiencing excessive IRAT handovers through multiple cell sites and multiple markets, the IRAT optimization logic 318 may adjust handover thresholds for the impacted device model or alternatively assign the device model permanently to a particular RAT. Thus, two thresholds may be examined prior to determining an optimization is necessary. First, IRAT transitions per user are compared to a predetermined threshold and users experiencing excessive transitions are flagged. Secondary, a comparison is performed to a second threshold with respect to one or more of the above-identified variables to determine when the number or percentage of users experiencing the threshold number of transitions meets the second threshold.

Processor 310 may be a microprocessor and may include hardware circuitry and/or embedded codes configured to retrieve and execute software stored in storage device 315. The IRAT transition analyzer 300 may include a communication interface 320 and a user interface 325. Communication interface 320 may be configured to enable the processing system 305 to communicate with other components, nodes, or devices in the wireless network. For example, the IRAT transition analyzer 300 can share intelligence including the tracking logic 312, analysis logic 316, and optimization logic 318 with the access nodes 110a, 110b, 210a, and 210b and/or the core network 102a, 102b, 202.

Communication interface 320 may include hardware components, such as network communication ports, devices, routers, wires, antenna, transceivers, etc. User interface 325 may be configured to allow a user to provide input to the IRAT transition analyzer 300 and receive data or information from the IRAT transition analyzer 300. User interface 325 may include hardware components, such as touch screens, buttons, displays, speakers, etc. The IRAT transition analyzer 300 may further include other components such as a power management unit, a control interface unit, etc.

The IRAT transition analyzer 300 thus may utilize the memory 315 and the processor 310 to perform multiple operations. For example, the processor 310 may access stored instructions in the memory 315 to determine a number of IRAT handovers within a predetermined time period, whether the handovers are deemed excessive, how the handovers correlate with other variables, and how an optimization can be performed to minimize the handovers.

The location of the IRAT transition analyzer 300 may depend upon the network architecture. For example, in smaller networks, a single IRAT transition analyzer 300 may be disposed for communication with core networks 102a, 102b, 202, and access nodes 110a, 110b, 210a, 210b shown in FIGS. 1 and 2. However, in a larger network, multiple IRAT transition analyzers 300 may be required to cover the network. Further, the functions of the IRAT transition controller 300 may be split between the core network 102a, 102b, 202 and the RAN 170a, 170b, 270.

The methods, systems, devices, networks, access nodes, and equipment described herein may be implemented with, contain, or be executed by one or more computer systems and/or processing nodes. The methods described above may also be stored on a non-transitory computer readable medium. Many of the elements of environments 100, 200, or 300 may be, comprise, or include computers systems and/or processing nodes, including access nodes, controller nodes, and gateway nodes described herein.

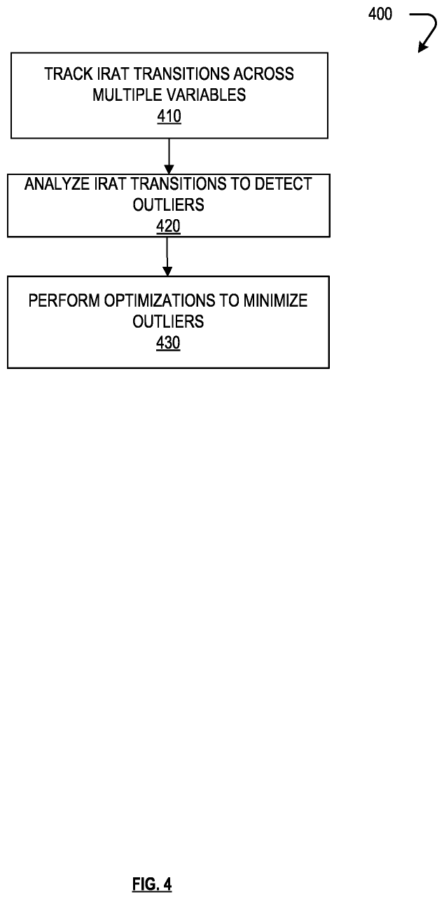

The disclosed methods for minimizing IRAT transitions are discussed further below. FIG. 4 illustrates an exemplary method 400 for minimizing IRAT transitions. Method 400 may be performed by any suitable processor discussed herein, for example, a processor 310 included in the IRAT transition analyzer 300. For discussion purposes, as an example, method 400 is described as being performed by the processor 310 of the IRAT transition analyzer 300.

Method 400 begins in step 410, when the IRAT transition analyzer 300 monitors IRAT transitions for multiple wireless devices, such as 122, 124, 126, 128. For example, the analyzer 300 may track IRAT transitions monitored at the core network 102a, 102b, 202. The processor 310 of the IRAT transition analyzer 300 may track the number of transitions for each wireless device occurring within a preset time period, for example, one day, one hour, or thirty minutes. The IRAT transition analyzer 300 may track the transitions across multiple variables, including, for example, vendor, market, cell site, device model, subscriber, frequency band, and TAC. For example, the processor 310 may execute tracking logic in the form of the following executable code:
select
date_part.
hour_part,
market,
vendor,
Band,
TAC_DEC,
count (distinct subscription_permanent_identifier) as SUB_Count,
SUM(CASE WHEN procedure_id=‘5’ and procedure_subtype=‘14’ THEN 1 ELSE 0 END) AS a5GS_to_EPS,
SUM(CASE WHEN procedure_id=‘1’ and procedure_subtype=‘2’ and concurrent_procedure_id1=‘21’ THEN 1 ELSE 0 END) AS EPS_to_5GS_Mobility_Registration,
SUM(CASE WHEN procedure_id=‘18’ THEN 1 ELSE 0 END) AS 5GS_to_EPS_Handover,
SUM(CASE WHEN procedure_id=‘19’ THEN 1 ELSE 0 END) AS 5GS_to_EPS_Idle_Mode
from
   (select
   date_part,
   hour_part,
   <time hh:mm:ss>
   market,
   vendor,
   tac_device_name device_name,
   current_nr_cell,
   CONV(SUBSTRING(current_pr_cell,9,9),16,10) nr_cell,
   cellref.band
   cellref.site_name
   subscription_permanent_identifier,
   procedure_id,
   procedure_subtype,
   concurrent_procedure_id1
   from integration.amf_pmd_um,join cell_ref
   where
   date_part>=‘2023-05-01’)

As a result of executing this code, the processor 310 tracks different types of IRAT transitions across multiple variables by leveraging information stored at the core network. In this specific example, 4G evolved packet system (EPS) to 5G and 5G to EPS transitions are tracked. Further, these transitions are tracked by date and by hour. Correlating variables including market, vendor, TAC, device name, RF band, cell site, and subscription identifier (IMSI) are also tracked.

In step 420, the IRAT transition analyzer 300 may analyze IRAT transitions to detect outliers using the transition analysis logic 316. The IRAT transition analyzer 300 may store a threshold number of IRAT transitions that may ordinarily occur for each user in the predetermined time period. The IRAT transition analyzer 300 may compare the counted number of transitions to the stored threshold number to detect outliers in terms of numbers of transitions. Based on the tracking procedure described above, the IRAT transition analyzer 300 may correlate the outliers with the additional variables as illustrated. In embodiments provided herein, the analysis may include the provision of visual tools enabling drilling down on the additional variables to illustrate correlations with excessive IRAT transitions and further identify IRAT transactions outside of expected boundaries and thus identify the source of excessive signaling.

Finally, in step 430, the IRAT transition analyzer 300 may trigger or recommend optimizations based on the analysis. For example, in some instances, the source of excessive transitions may be tracked to a particular location, such as a market, a TAC or a cell site. In other instances, the source of the excessive transitions may be associated with a particular device model or a particular frequency band. Accordingly, the processor 310 executes IRAT optimization logic 318 to recommend or trigger optimizations based on the variables correlating to the excessive signaling. For example, if a particular cell site is correlated with excessive signaling, RAN optimization may be recommended to adjust transmit power of a base station or change an angle of transmission. If a particular market is identified as correlated with the excessive signaling, the processor 310 may trigger adjustments to the core network to extend a coverage area, such as, for example, the 5G standalone coverage area. Further, handover thresholds may be adjusted to minimize transitions. Through these optimizations, the IRAT transition analyzer 300 is able to minimize outliers and thus minimize excessive signaling to the core network.

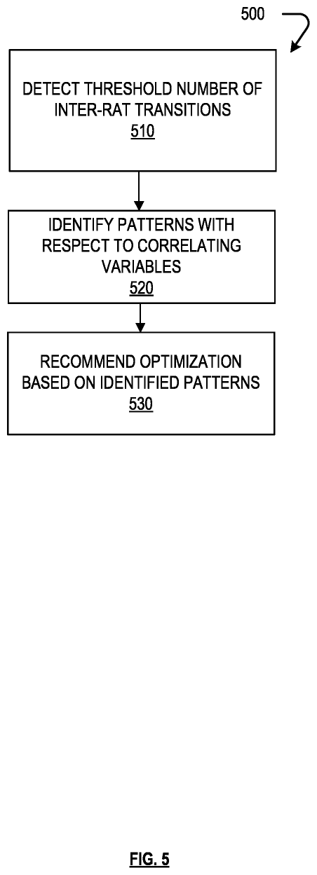

FIG. 5 illustrates an exemplary method 500 for analysis of IRAT transitions in accordance with embodiments disclosed herein. Method 500 may be performed by any suitable processor discussed herein, for example, a processor 310 included in the IRAT transition analyzer 300. For discussion purposes, as an example, method 500 is described as being performed by the processor 310 of the IRAT transition analyzer.

Method 500 begins in step 510, when the IRAT transition analyzer 300 detects a threshold number of IRAT transitions per user. As set forth above, the processor 310 of the IRAT transition analyzer 300 may count the number of transitions for each wireless device occurring within a preset time period, for example, one hour, or thirty minutes. The IRAT transition analyzer 300 may store a threshold number of transitions, for example, one hundred transitions that may occur within this pre-set time period. The IRAT transition analyzer 300 may compare the counted number of transitions to the stored threshold number. Upon finding that the number of transitions meets or exceeds this stored threshold number in step 510, the method proceeds to step 520.

In step 520, the IRAT transition analyzer 300 identifies patterns with respect to correlating variables. This may be accomplished utilizing a second threshold. The correlating variables may include, for example, type of device, market, RF band, TAC, cell site, etc. For example, the IRAT transition analyzer 300 identifies a particular device that is prone to excessive IRAT transitions or a particular cell site that is prone to excessive IRAT transitions. These data points are characterized as outliers that methods and systems disclosed herein seek to minimize. Thus, the IRAT transition analyzer 300 identifies a handover trigger as related to a particular device type, a particular access node serving a cell site, a particular market, etc. The identification of these data points can be achieved through comparison of the number of users experiencing the threshold IRAT transitions to a second network specific threshold that may be specific to each considered variable. The second threshold may be a percentage or a set number. For example, if more than 25% of the users of the iPhone 13® are experiencing excessive IRAT transitions per user then a network optimization for the iPhone 13® users will be recommended. As another example, if more than 20% of users in a particular cell site are experiencing the excessive IRAT transitions per user, the cell site will be flagged for optimization.

Finally, in step 530, the IRAT transition analyzer 300 selects and recommends or triggers an optimization based on the identified pattern. For example, in the case of a particular wireless device model having excessive handovers, the IRAT transition analyzer may assign the device to a particular RAT to avoid excessive transitions. Alternatively, the IRAT transition analyzer 300 may adjust handover thresholds that apply to the wireless device, for example, thresholds that may be set by the device manufacturer. Further, in some embodiments, the IRAT transition analyzer 300 may send an update to the core network, for example to the UDM in order to override on OEM RAT assignment. Thus, the processor 310 may identify the model and make of a wireless device as the trigger based on tracked information as wireless devices may send a type including its make, model, chipset, etc. to the access node. Certain original equipment manufacturers (OEMs), such as Apple®, have their own implementations pertaining to RAT selection. Thus in order to optimize, processor 310 may disable support of a particular RAT for a device make and model. Alternatively, when a particular cell site experiences excessive transitions, the IRAT transition analyzer 300 may adjust the handover thresholds for the cell site or adjust transmit power of the access node. If an entire market experiences excessive outages, a network misconfiguration may be identified. The IRAT transition analyzer 300 may adjust core network parameters, for example by extending standalone coverage or by adjusting thresholds or timers to keep wireless devices on 5GNRSA to avoid transitions to LTE. Further, as another example, the IRAT transition analyzer 300 may disable only a certain frequency band or layer when these bands or layers are repeatedly implemented in unnecessary handovers.

In some embodiments, methods 400 and 500 may include additional or fewer steps or operations. Furthermore, the methods may include steps shown in each of the other methods. As one of ordinary skill in the art would understand, the methods 400 and 500 may be integrated in any useful manner. Further, the order of the steps shown is merely exemplary and the order of steps may be rearranged in any useful manner.

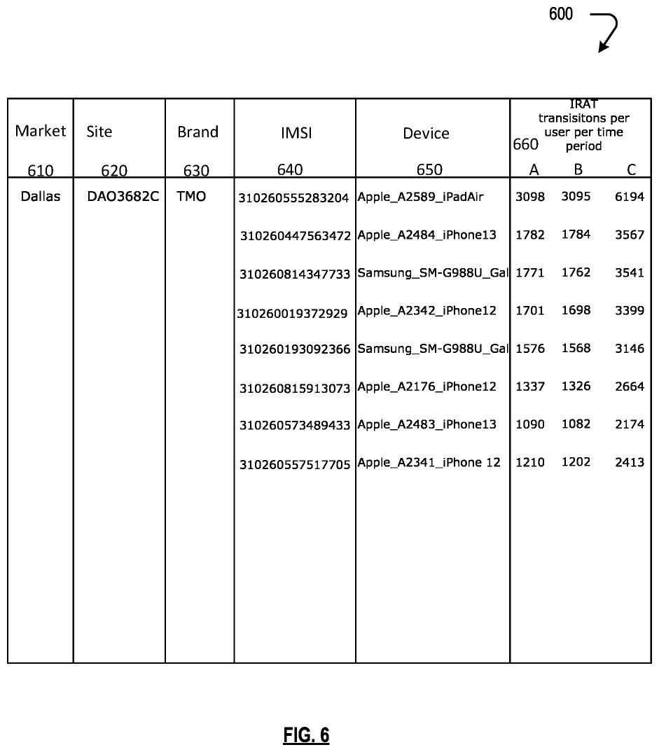

FIG. 6-10 illustrate dashboard interfaces that may be created by the IRAT transition analyzer 300. FIG. 6 illustrates a dashboard interface 600 that characterizes IRAT transitions per user 660 in relation to market 610, cell site 620, brand 630, IMSI 640, and device 650. In the illustrated embodiments, one cell site 620 of the Dallas market 610 is shown. The data includes the IMSI 640, which is subscriber level data identifying a particular subscriber. The device 650 identifies a particular make and model of device. The IRAT transition data 660 includes EPS to 5G mobility transitions A and 5G to EPS transitions in idle mode B. A total number of transitions per time period for each device is shown at C.

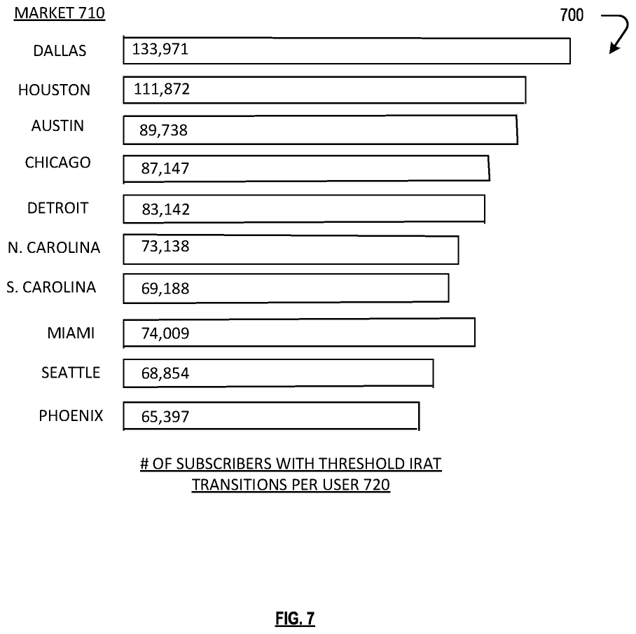

FIG. 7 illustrates a market analysis dashboard 700 illustrating multiple markets 710 and a number of subscribers in each market experiencing a threshold number of IRAT transitions per user 720 in each market. This dashboard interface 700 helps correlate IRAT transitions by market to identify markets that should be targeted for optimization. For example, in the illustrated embodiment, at least the Dallas and Houston markets would be targeted for optimization.

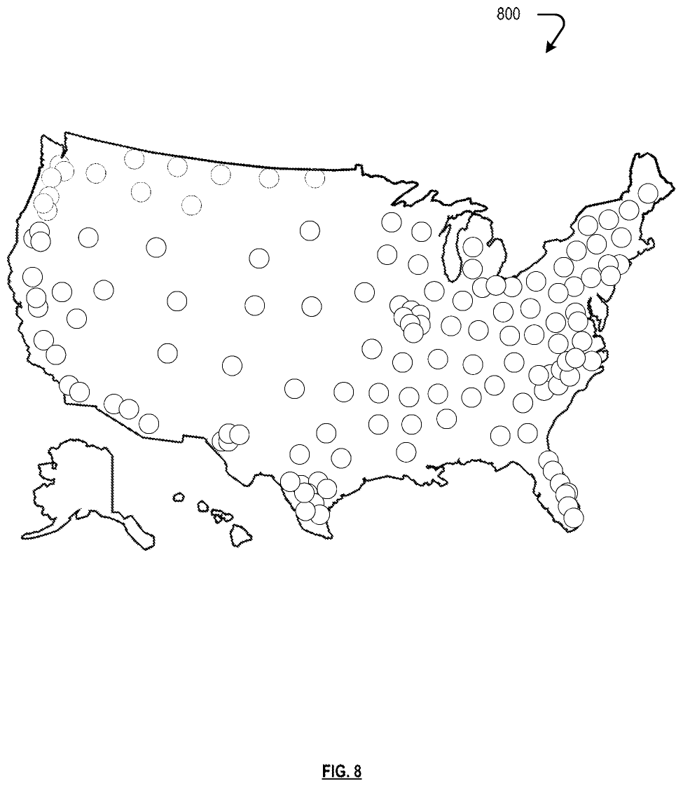

FIG. 8 illustrates a further market analysis dashboard 800 illustrating the multiple markets on a map. The density of circles on the map shows the concentration of users experiencing a threshold number of IRAT transitions in a selected time period. Accordingly, where the circles are densely populated, larger numbers of user in the market are experiencing a threshold number of IRAT transitions per user. The mapping tools provides a visual continuity to enable identification of concentrations of excessive IRAT transitions. In further embodiments, the map may utilize colors to illustrate concentrations of excessive transitions, for example with red being the most concentrated, yellow being less concentrated, and green being the least concentrated.

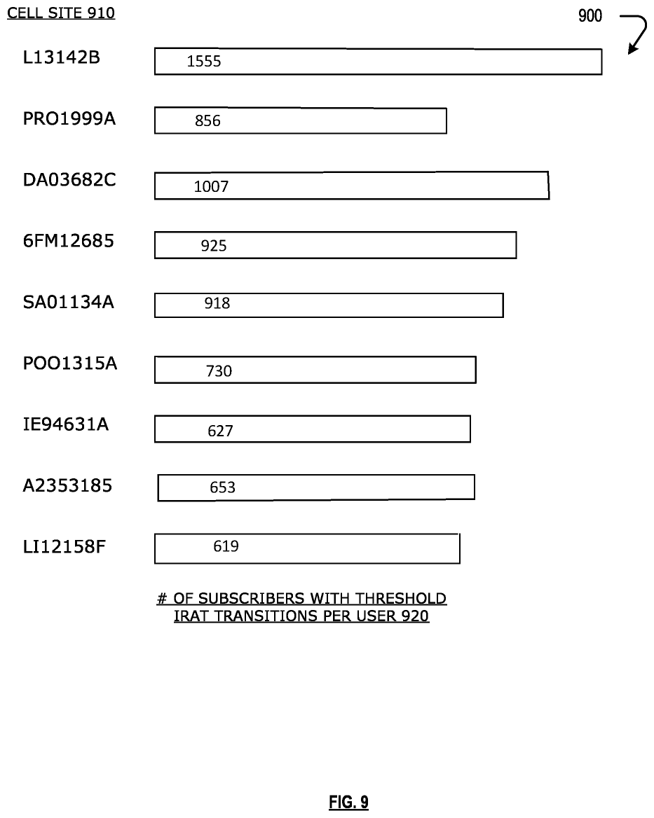

FIG. 9 illustrates a further dashboard interface 900 of the IRAT transition analyzer 300. A number of users experiencing a threshold number IRAT transitions within a selected time period is plotted against cell site. This dashboard interface 900 helps to identify cell sites where an excessive number of IRAT transitions are occurring.

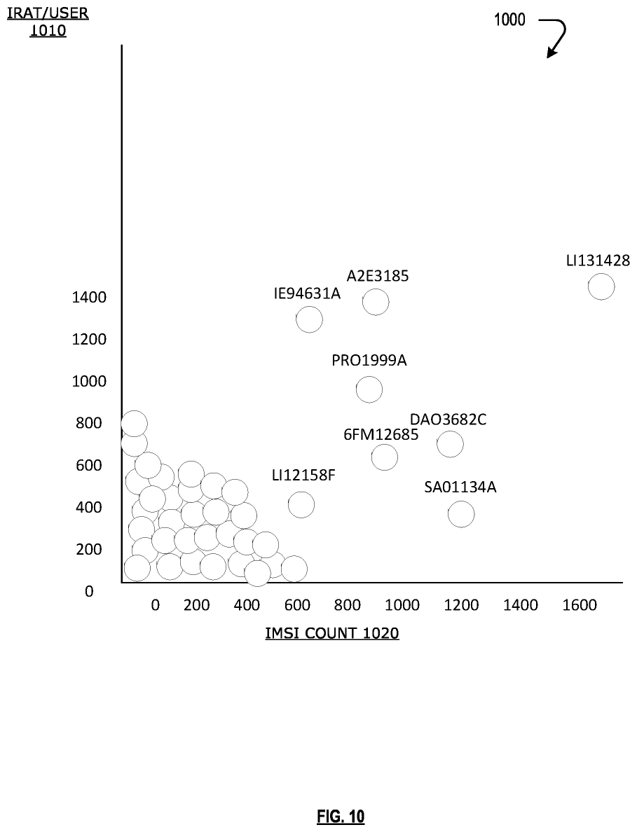

FIG. 10 illustrates a further dashboard interface 1000 including IRAT per user 1010 plotted against IMSI count 1020, where every circle represents a cell site. Accordingly, the interface 1000 allows quick identification of outlier among the cell sites. While most cell sites are concentrated in the lower left hand corner of the interface, outliers are dispersed in other areas of the interface. The outliers illustrate cell sites having a large number of individual subscribers experiencing excessive IRAT transitions. In embodiments disclosed herein, network optimizations are triggered or recommended for these outlying cell sites.

The optimizations performed herein may encompass, for example, extending standalone coverage, optimizing handover thresholds and timers to retain traffic on 5GNRSA and avoid transitions to 4G LTE, providing faster transitions between SA layers, removal of aggressive mobility settings, and alignment of power configurations. These optimizations reduce transactions per second (TPS) recorded by the core network. Both front end and back end transactions are reduced.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
tracking Inter-radio access technology (IRAT) transitions within a network;
comparing a number of IRAT transitions per user to a threshold;
identifying excessive IRAT transitions based on the comparison; and
generating a recommendation for optimization based on the identification.

2. The method of claim 1, further comprising tracking the IRAT transitions in conjunction with at least one correlating variable.

3. The method of claim 2, further comprising identifying IRAT transitions per user by wireless device type, wherein a wireless device type is the correlating variable.

4. The method of claim 2, further comprising identifying a tracking area code (TAC) as the correlating variable.

5. The method of claim 2, further comprising identifying IRAT transitions per user at a subscriber level by international mobile subscriber identity (IMSI), wherein the IMSI is the correlating variable.

6. The method of claim 2, further comprising identifying IRAT transitions per user by cell site, wherein the cell site is the correlating variable.

7. The method of claim 2, further comprising identifying IRAT transitions per user by radio frequency (RF) band, wherein the RF band is the correlating variable.

8. The method of claim 7, further comprising performing the optimization based on the correlating variable to minimize IRAT transitions.

9. The method of claim 7, wherein the optimization includes adjusting at least one handover threshold.

10. The method of claim 7, wherein the optimization includes a timer associated with a handover threshold.

11. The method of claim 7, wherein the optimization comprises adjusting parameters to extend a stand-alone coverage area.

12. A system comprising:
a memory storing data and instructions, the data including at least a threshold number of inter-radio access technology (IRAT) transitions per user; and
a processor accessing the stored data and executing the stored instructions to perform operations including;
tracking IRAT transitions within a network;
comparing a number of IRAT transitions per user to the stored threshold;
identifying excessive IRAT transitions based on the comparison; and
generating a recommendation for resource optimization based on the identification.

13. The system of claim 12, the operations further comprising identifying at least one correlating variable with the excessive IRAT transitions.

14. The system of claim 13, the operations further comprising performing an optimization based on the correlating variable to minimize IRAT transitions.

15. The system of claim 14, wherein the optimization includes adjusting at least one handover threshold.

16. The system of claim 14, wherein the optimization includes at least one timer associated with a handover threshold.

17. The system of claim 14, wherein the optimization comprises adjusting parameters to extend a stand-alone coverage area.

18. A method comprising:
tracking Inter-radio access technology (IRAT) transitions within a network in conjunction with correlating variables;
comparing a number of IRAT transitions per user to a threshold;
identifying excessive IRAT transitions based on the comparison; and
generating a recommendation for resource optimization based on the identification and the correlating variables.

19. The method of claim 18, further comprising generating different recommendations based on different correlating variables.

20. The method of claim 19, wherein the correlating variable include at least one of a market, a vendor, a cell site, a wireless device type, or a radio frequency band.
